(19) United States
(12) Patent Application Publication
(10) Pub. No.: US 2013/0330254 A1
(43) Pub. Date: Dec. 12, 2013

(54) EXPANDIBLE AND CONTRACTIBLE TUBE RACK

(71) Applicant: HEATHROW SCIENTIFIC LLC, Vernon Hills, IL (US)

(72) Inventors: Michael R. Jensen, Roselle, IL (US); Mark Eyman, Chicago, IL (US); Patrick Nally, Chicago, IL (US); Trevis Kurz, Chicago, IL (US)

(73) Assignee: HEATHROW SCIENTIFIC LLC, Vernon Hills, IL (US)

(21) Appl. No.: 13/801,970

(22) Filed: Mar. 13, 2013

Related U.S. Application Data
(60) Provisional application No. 61/656,420, filed on Jun. 6, 2012.

(51) Int. Cl. B01L 9/06

(52) U.S. Cl. CPC B01L 9/06
USPC 422/562

(57) ABSTRACT

A tube rack generally includes two or more rows of wells and at least one coupling member for coupling a pair of rows. The rows extend substantially parallel to one another. Each coupling member is configured to adjust a distance between the pair of rows as the rows of wells are separated or pushed together, thereby enabling the tube rack to expand and contract.

### BACKGROUND

For laboratory work that requires test tubes, a tube rack can be used to organize, carry, and store the test tubes. The tube rack typically includes a container with a plurality of wells formed therein. The wells receive the test tubes. The container can be covered with a lid. Once test tubes are positioned within the wells, the assembly of the tube rack and test tubes can be subjected to further processing such as refrigeration or autoclaving.

For laboratory work that requires test tubes or vials, laboratory professionals typically use a tube rack to organize, carry, and store the test tubes. In operation, the tube rack is positioned on a bench top or other support structure. The laboratory professional may load or position test tubes within the tube rack, and access or retrieve the positioned test tubes for laboratory work. The tube rack is typically required to have a compact footprint for further processing such as refrigeration or autoclaving, and the test tubes are frequently positioned in close proximity to one another. Retrieving or working on a single test tube from a closely positioned group of test tubes can be difficult or cumbersome. For example, a laboratory professional may try to retrieve a particular test tube from the tube rack, yet may unintentionally end up removing the wrong one from the tube rack. Retrieving or working on the desired test tube from the closely positioned group of test tubes may also be time-consuming, particularly, if a laboratory professional needs to access a large volume of test tubes. Repeatedly loading and retrieving the test tubes from the closely positioned group of test tubes can be time-consuming and cumbersome. Moreover, the laboratory professional may unintentionally end up contacting adjacent test tubes in the process, thereby disturbing the contents or solutions within the test tubes and potentially damaging the test tubes. There is also the inconvenience of having micro-tubes with hinged lids interfering with adjacent tubes. In fact, many laboratory professionals often skip rows or columns of wells to give adequate space between tubes. This is often inefficient because a large percentage of the existing racks may go unused. Thus, there has developed a need for a tube rack that stores test tubes in a compact footprint, yet makes loading and retrieving the test tubes efficient, user-friendly, and tidy.

### SUMMARY

In some embodiments, a tube rack generally includes two or more rows of wells and at least one coupling member for coupling a pair of rows. The rows extend substantially parallel to one another. Each coupling member is configured to adjust a distance between the pair of rows as the rows of wells are separated or pushed together, thereby enabling the tube rack to expand and contract.

In other embodiments, a tube rack generally includes three or more rows of wells and at least two coupling members for coupling a respective pair of rows. The rows extend substantially parallel to one another. Each row has two or more wells and defines a longitudinal axis. Each coupling member is configured to adjust a distance between the respective pair of rows as the rows of wells are separated or pushed together in a direction substantially perpendicular to the longitudinal axes, thereby enabling the tube rack to expand and contract.

Other aspects of the invention will become apparent by consideration of the detailed description and accompanying drawings.

### BRIEF DESCRIPTION OF THE DRAWINGS

FIG. 1 is a perspective view of a tube rack according to one embodiment of the invention, illustrating the tube rack as contracted to a storage configuration.

FIG. 2 is an exploded view of the tube rack of FIG. 1, illustrating rows of wells and sliding caps for slidably coupling a pair of rows.

FIG. 3 is an enlarged perspective view of one row of the wells of FIG. 2.

FIG. 4 is a side view of the wells of FIG. 3.

FIG. 5 is a side view similar to FIG. 4, but illustrating an inner row.

FIG. 6 is a side view similar to FIG. 5, but illustrating another inner row.

FIG. 7 is a side view similar to FIG. 6, but illustrating yet another inner row.

FIG. 8 is a side view similar to FIG. 5, but illustrating a reversible row.

FIG. 9 is an enlarged perspective view of the sliding cap of FIG. 2.

FIG. 10 is a perspective view of the tube rack of FIG. 1, illustrating the tube rack as being partially expanded.

FIG. 11 is a perspective view similar to FIG. 10, but illustrating the tube rack as fully expanded to the operating configuration.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

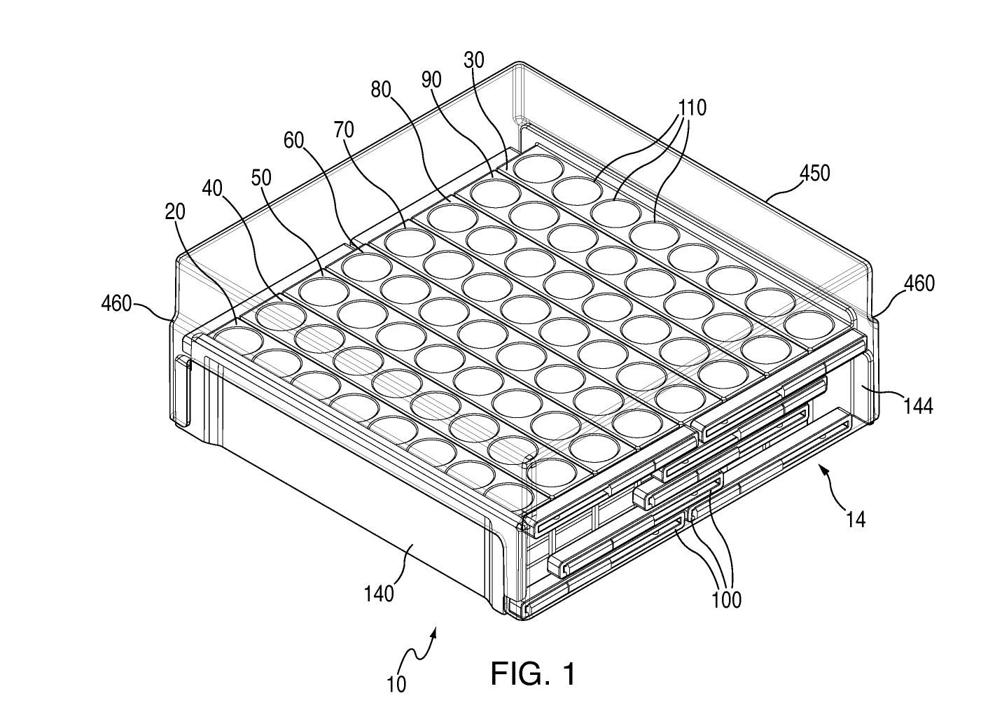

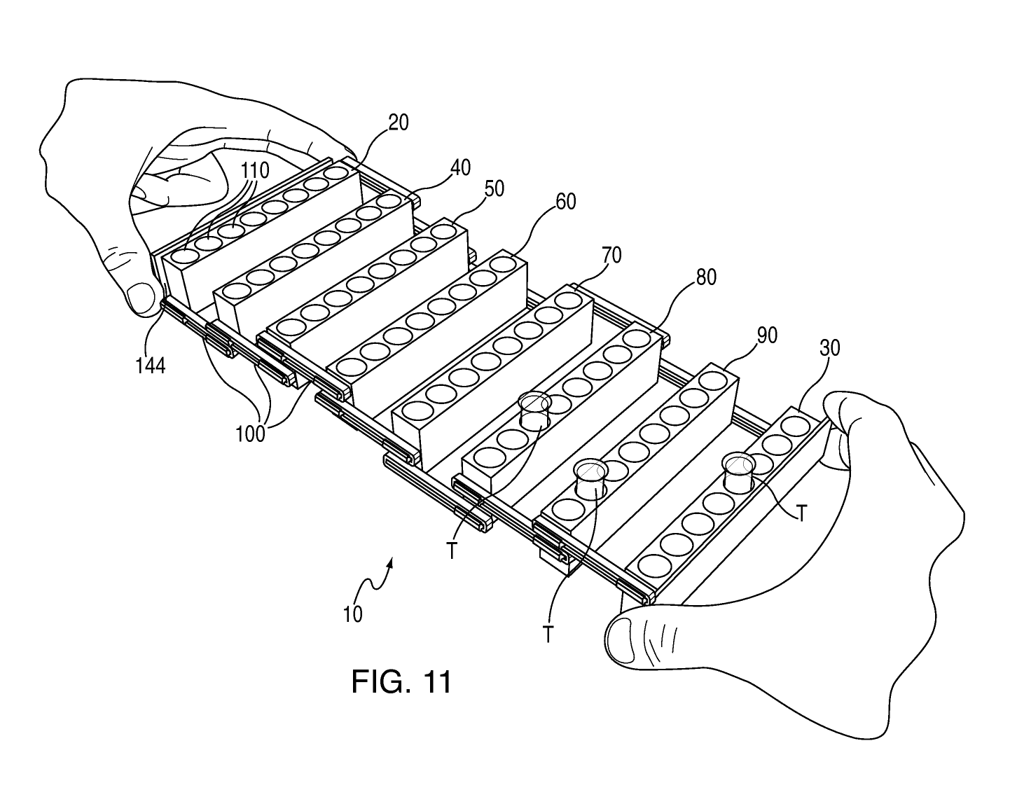

A tube rack 10 is configured to expand to an operating configuration (see FIG. 11) and contract to a storage configuration (see FIG. 1). In the illustrated embodiment, the tube rack 10 includes two end rows of wells 20, 30, and six inner rows of wells 40, 50, 60, 70, 80, and 90. A plurality of sliding caps or tabs 100 is provided for slidably coupling respective pairs of rows, as will be explained further below. All or parts of the tube rack 10 can be molded or formed from any suitable plastic such as polypropylene, or can be made in other manners from other materials.

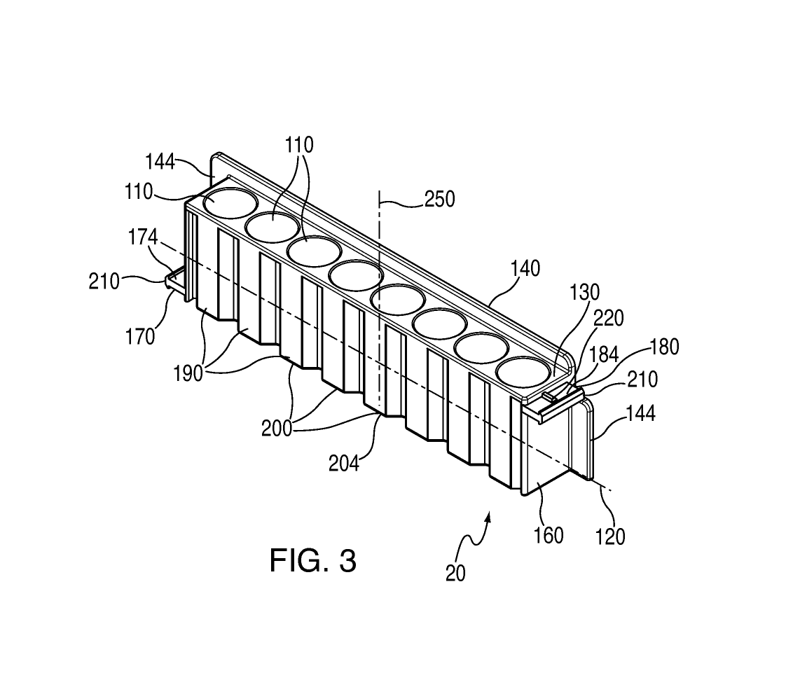

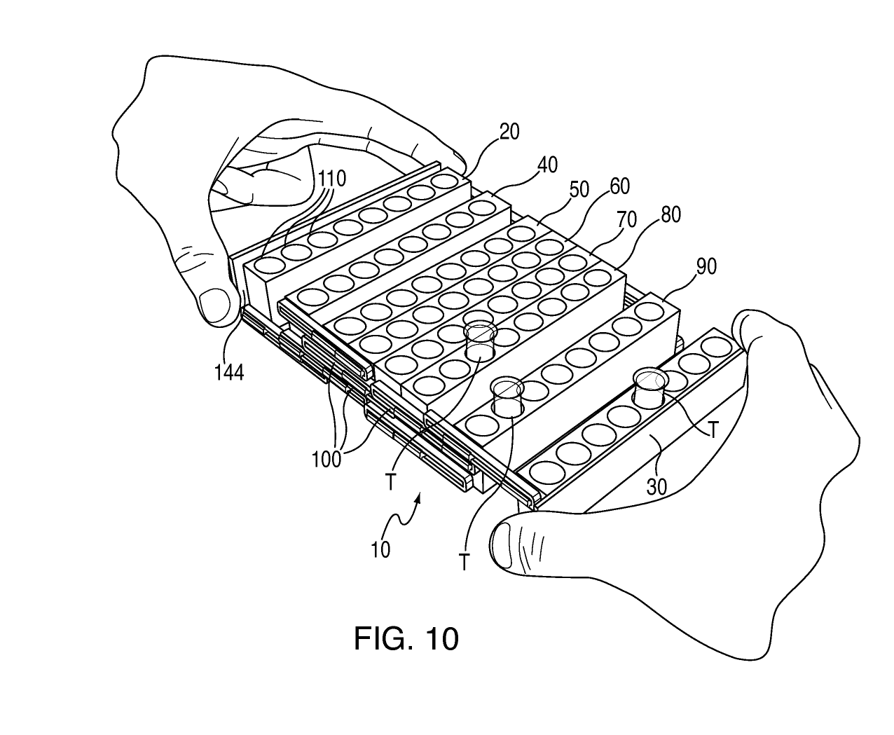

Each row 20, 30, 40, 50, 60, 70, 80, and 90 includes one more wells 110 positioned adjacent to and spaced from one another in series, defining a respective longitudinal axis 120 (FIG. 3). In the illustrated embodiment, the tube rack 10 includes eight rows of wells 20, 30, 40, 50, 60, 70, 80, and 90, which each include eight wells 110 so that the tube rack 10 can house or contain up to 64 test tubes T (not shown in FIG. 1; see FIGS. 10 and 11). In other embodiments, the tube rack 10 can suitably include other numbers of rows and/or other numbers of wells 110, and can therefore house other numbers of test tubes T. In the illustrated embodiment, the wells 110 within each row abut one another substantially without a gap therebetween. In other embodiments, at least some of the wells 110 may be coupled to one another with a gap therebetween (e.g., via a connector).

In some embodiments, each test tube T has an internal volume of about 0.2 ml to about 2.0 ml, and each well 110 is dimensioned to house at least a part of the test tube T. For example, each well 110 can be generally cylindrical with a top circular opening measuring about 13 mm in diameter, and a base positioned about 28 mm below the top circular opening for receiving the test tube therein. As used herein, the terms “top,” “bottom,” “front,” “rear,” “side,” and other directional terms are not intended to require any particular orientation, but are instead used for purposes of description only. In other embodiments, one or more of the wells 110 can be dimensioned differently to accommodate a test tube T with a different internal volume. In still other embodiments, one or more of the wells 110 may assume any other suitable geometric form, including a conical shape wherein the cross section of the well 110 tapers gradually in thickness in a direction away from the top circular opening toward the base. In still other embodiments, one or more of the wells 110 may include a locking mechanism to hold the test tube T in place. For example, the well 110 may include an internal thread (not shown) that cooperates with a corresponding thread (not shown) on the test tube T to securely hold the test tube T in place. Other embodiments can reflect top opening shapes other than circular, such as square, triangular, or hexagonal, for instance.

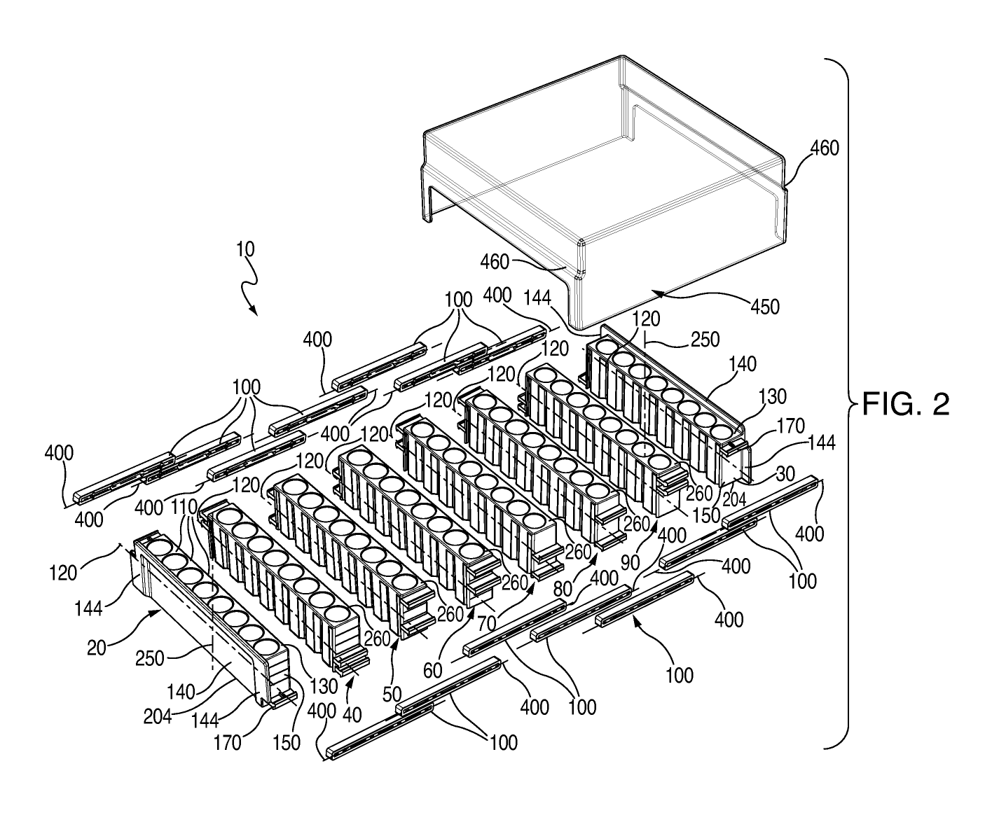

Referring also to FIGS. 2-4, each end row of wells 20, 30 has a generally rectangular box shape with a top wall 130, a side wall 140, and a pair of end walls 150, 160 that are each joined to the top and side walls 130, 140 at substantially right angles. A bottom 204 of each of the rows 20, 30 is defined by one or more bases 200 of the wells 110. The illustrated side wall 140 includes tabs 144 that extend away from the respective end wall 150, 160. As will be explained further below, a user can grip or hold the tabs 144 to expand and contract the tube rack 10. Projections 170 and 180 extend from the end walls 150 and 160, respectively. The configurations of the end rows 20, 30 are generally the same, and will be described only with reference to the first end row 20, although the description is equally applicable to the second end row 30. In the illustrated embodiment, the longitudinal axis 120 generally extends from one end wall 150 to the other end wall 160. The wells 110 are generally cylindrical and substantially evenly spaced along the longitudinal axis 120, with a tube-receiving wall 190 extending substantially perpendicular to the longitudinal axis 120.

In the illustrated embodiment, each of the projections 170, 180 extends laterally at different heights relative to the bottom 204, and away from the respective end wall 150, 160 in an orientation substantially parallel to the longitudinal axis 120 and to top wall 130. In other embodiments, one or more of the projections 170, 180 may assume other shapes, e.g., a pin shape. The first projection 170 is positioned near the base 200 of the wells 110, while the second projection 180 is positioned near the top wall 130. In some embodiments, the projections 170, 180 are co-molded or otherwise integrated with the respective end wall 150, 160. In other embodiments, however, one or more of the projections 170, 180 may be coupled to the respective end wall 150, 160 using any suitable fastening mechanism, e.g., using glue.

In the illustrated embodiment, each of the projections 170, 180 includes a head portion 210 that is larger in cross section relative to an adjacent body portion 174, 184 of the respective projection 170, 180. In other embodiments, however, fewer than all of the projections 170, 180 may include the head portion 210. Each of the projections 170, 180 includes a pair of protrusions 220, 230 (only the upper protrusion 220 is shown on the projection 180 in FIG. 3; the lower protrusion 230 is positioned substantially symmetrical relative to the projection 180 and therefore on an underside of the projection 180). As will be explained further below, the upper and lower protrusions 220, 230 fixedly couple the end rows 20, 30 to a corresponding sliding cap 100.

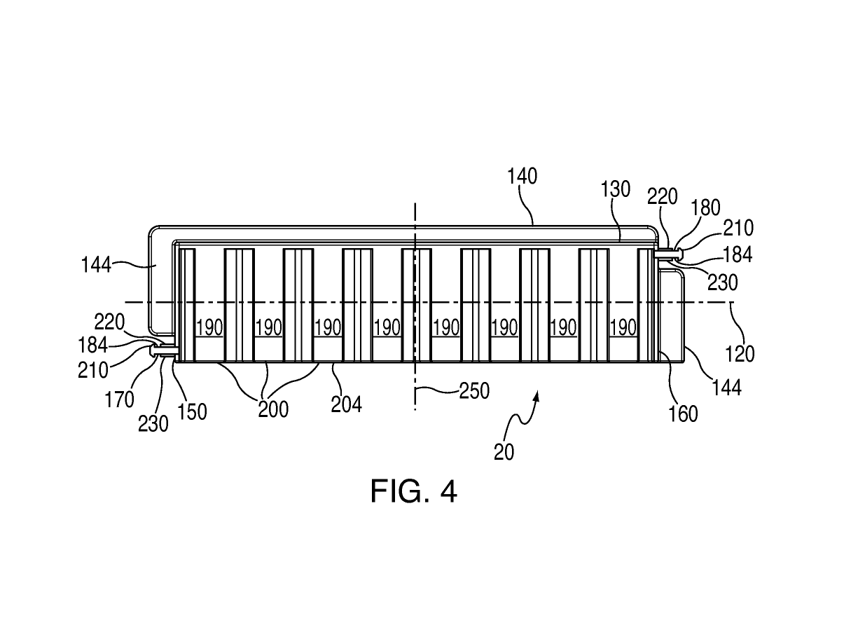

Referring to FIG. 4, the upper protrusion 220 extends upwardly from the respective projection 170 or 180, and the lower protrusion 230 extends downwardly from the respective projection 170 or 180. The upper and lower protrusions 220 and 230 each project away from adjacent body portions 174, 184 of the respective projections 170 or 180. In the illustrated embodiment, both the upper and lower protrusions 220 and 230 are semi-cylindrical. In other embodiments, however, one or more of the protrusions 220 and 230 may assume any other suitable geometrical form, including, but not limited to, a regular polyhedral, and an irregular polyhedral shape, derivatives thereof, and combinations thereof. In still other embodiments, the projections 170 and 180 may include fewer than both of the protrusions 220, 230.

In the illustrated embodiment, the projections 170 and 180 are substantially symmetrical when viewed from above along a centerline axis 250 extending substantially perpendicular to the longitudinal axis 120. That is, the projections 170 and 180 each extend from the respective end wall 150, 160 to substantially the same length. As will be explained further below, the symmetrical shape of the projections 170, 180 makes the end rows 20, 30 interchangeable for assembling the tube rack 10 and thereby facilitates a modular construction of the tube rack 10. In other embodiments, however, the projections 170, 180 are not necessarily symmetrical when viewed along the centerline axis 250.

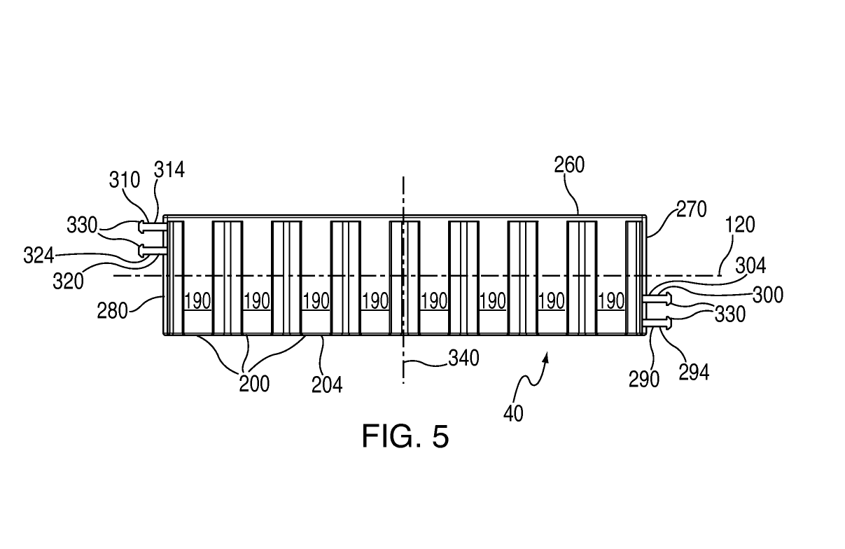

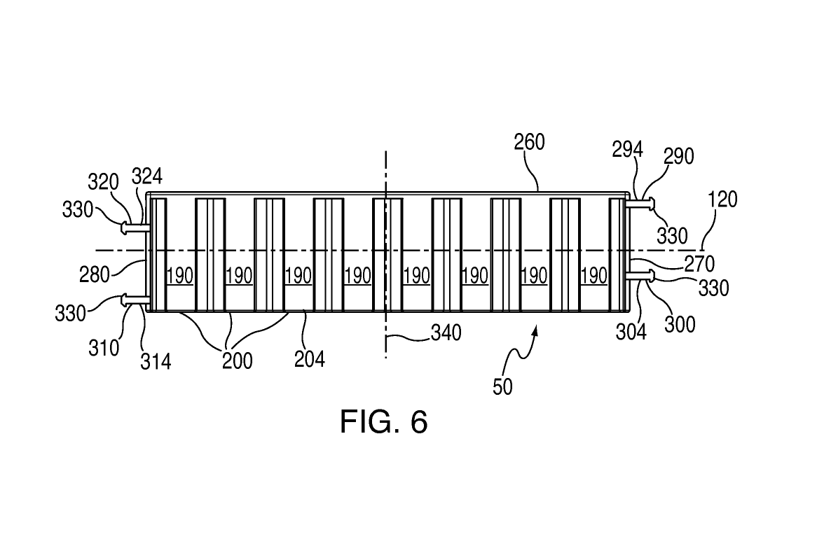

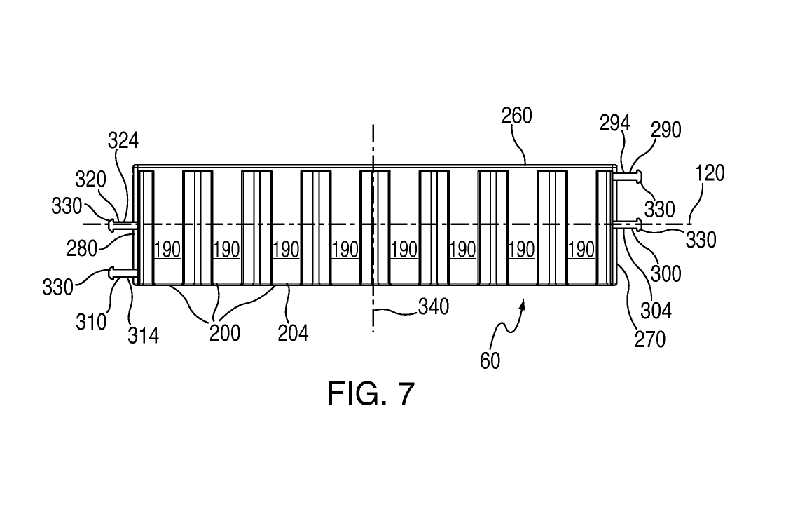

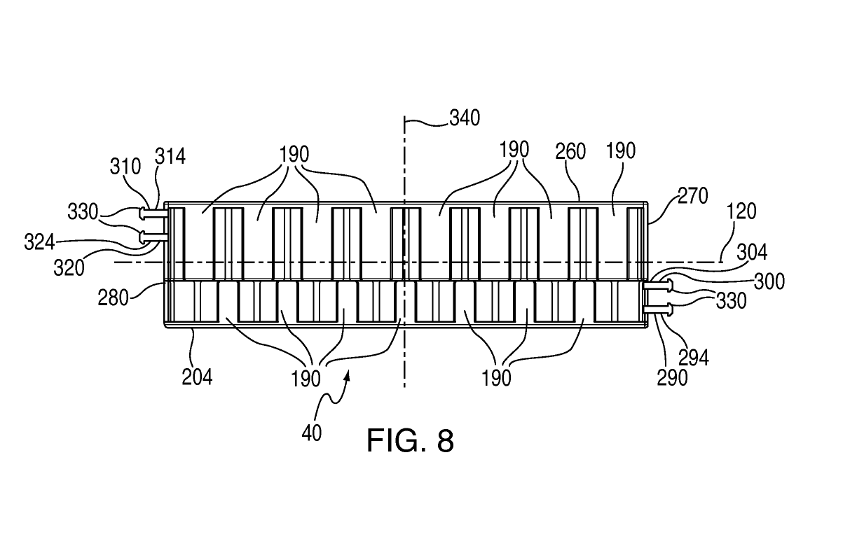

Referring also to FIGS. 5-7, the tube rack includes six inner rows of wells 40, 50, 60, 70, 80, and 90. In the illustrated embodiment, the six inner rows of wells 40, 50, 60, 70, 80, and 90 can be grouped into three pairs: the first inner rows of wells 40, 90 (see FIG. 5); the second inner rows of wells 50, 80 (see FIG. 6); and the third inner rows of wells 60, 70 (see FIG. 7). The configuration of each inner row is the same within each pair. Each inner row of wells 40, 50, 60, 70, 80, and 90 has a generally rectangular box shape with a top wall 260 and a pair of end walls 270, 280 that are each joined to the top wall 250 at a substantially right angle. A bottom 204 of each of the rows 40, 50, 60, 70, 80, and 90 is defined by one or more bases 200 of the wells 110. Although FIGS. 5-7 illustrate the tube-receiving walls 190 extending only from the top wall 260 so that test tubes are inserted into and removed only from the top of the tube rack, in other embodiments, the tube rack can alternatively hold test tubes that are inserted into and removed from either the top or bottom of the rack. In those embodiments, at least one row of wells can include tube-receiving walls 190 extending from both the top wall 130, 260 and the bottom 204 of the respective row 20, 30, 40, 50, 60, 70, 80, and 90 (see FIG. 8). For example, the tube-receiving walls 190 extending from the top wall 130, 260 can be alternately spaced (i.e., offset laterally) with the tube-receiving walls 190 extending from the bottom 204, so that the tube rack (respective row 20, 30, 40, 50, 60, 70, 80, and 90) is reversible and either the top opening wells or the bottom opening wells can be accessed. In further embodiments, the tube-receiving walls 190 extending from the top wall 130, 260 can be dimensioned to receive test tubes T having a first internal volume (e.g., 0.5 ml), while the tube-receiving walls 190 extending from the bottom 204 can be dimensioned to receive test tubes T having a second internal volume (e.g., 0.2 ml).

The configurations of the inner rows 40, 50, 60, 70, 80, and 90 are generally similar to the end rows 20 and 30, but include a second projection on each end wall 270, 280 offset vertically from the first projection relative to the base 200 of the wells 110. That is, a pair of projections 290, 300 extends from the end wall 270 and another pair of projections 310, 320 extends from the end wall 280. Like the projections 170, 180 of the end rows 20, 30, in some embodiments, the projections 290, 300, 310, and 320 are co-molded or otherwise integrated with the respective end wall 270, 280. In other embodiments, however, one or more of the projections 290, 300, 310, 320 may be coupled to the respective end wall 270, 280 using any suitable fastening mechanism, e.g., using glue.

Each projection 290, 300, 310, 320 extends laterally at different heights relative to the bottom 204 and includes a respective head portion 330 that is larger in cross section relative to an adjacent body portion 294, 304, 314, 324 of the respective projection 290, 300, 310, 320. Unlike the end rows 20, 30, in the inner rows 40, 50, 60, 70, 80, and 90, the projections 290, 300, 310, and 320 are substantially free of protrusions. In other embodiments, one or more of the projections 290, 300, 310, 320 may assume other shapes, e.g., a pin-shape. In still other embodiments, fewer than all of the projections 290, 300, 310, 320 may include the head portion 330.

The projections 290, 300 are substantially symmetrical to the projections 310, 320 when viewed from above along a centerline axis 340 extending substantially perpendicular to the longitudinal axis 120. That is, the projections 290, 300, 310, 320 each extend from the respective end wall 270, 280 to substantially the same length. As will be explained further below, the symmetrical shape of the projections 290, 300 relative to the projections 310, 320 makes the rows within each pair interchangeable for assembling the tube rack 10 and thereby facilitates a modular construction of the tube rack 10.

Referring to FIG. 5, in the first inner rows of wells 40 and 90, the projections 290, 310 respectfully extend at substantially the same height as the projections 170, 180 of the end rows 20 and 30 relative to the top wall 260 and the base 200. The projection 300 extends at a height offset from the projection 290, i.e., slightly higher relative to the projection 290. Likewise, the projection 320 extends at a height offset from the projection 310, i.e., slightly lower relative to the projection 310. As will be explained further below, the offset projections 300, 320 are each receivable into a respective sliding cap 100 and enable the tube rack 10 to expand and contract.

Referring to FIG. 6, in the second inner rows of wells 50, 80, the projection 290 extends from the end wall 270 adjacent the top wall 260, and the projection 310 extends from the end wall 280 adjacent the base 200 of the wells 110. The projections 300, 320 each extend at substantially the same height as the projections 300, 320 of the first inner rows 40 and 90 relative to the top wall 260 and the base 200. As such, the projections 300 and 320 of the first and second rows 40, 50 are receivable into a laterally extending sliding cap 100.

Referring to FIG. 7, in the third inner rows of wells 60, 70, the projection 290 extends from the end wall 270 adjacent the top wall 260, and the projection 310 extends from the end wall 280 adjacent the base 200 of the wells 110, similar to the second inner rows of wells 50, 80. The projections 290 and 310 of the second and third rows 50, 60 are receivable into a laterally extending sliding cap 100. Both the projection 300 and the projection 320 extend at a height substantially midway between the top wall 260 and the base 200 of the wells 110. In the illustrated embodiment, the configurations of the rows 60 and 70 are generally the same; the row 70 is essentially the row 60 rotated 180° about the centerline axis 340. Thus, when the third inner rows 60 and 70 are positioned adjacent each other, the projection 300 of the row 60 and the projection 320 of the row 70 extend at substantially the same height relative to the top wall 260 and the base 200 and are receivable into a laterally extending sliding cap 100.

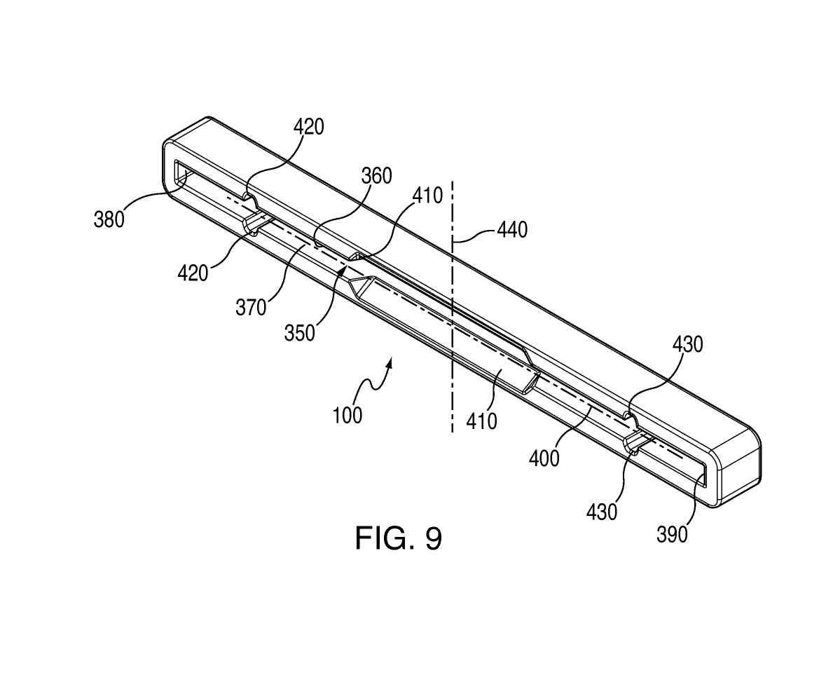

Referring to FIG. 9, each sliding cap 100 has a generally rectangular box shape and includes a projection-receiving channel 350 formed therein. The projection-receiving channel 350 is generally rectangular in cross section and is defined by inner surfaces 360, 370 extending along the top and bottom, respectively, and by a pair of inner surfaces 380, 390 extending along the two sides. The sliding cap 100 generally defines a longitudinal axis 400. In the illustrated embodiment, the rows of wells 20, 30, 40, 50, 60, 70, 80, and 90 each define an identical end portion width, and each sliding cap 100 has a length in a direction along the longitudinal axis 400 of approximately four times the end portion width. In other embodiments, at least one of the sliding caps 100 can have a length of approximately three times the end portion width or more.

In the illustrated embodiment, the projection-receiving channel 350 includes a pair of guiding surfaces 410. Along each guiding surface 410, the thickness of the cross section gradually tapers in a direction substantially perpendicular to the longitudinal axis 400 and away from the opening of channel 350. The guiding surfaces 410 can guide the head portions 210 of the end rows 20, 30 and the head portions 330 of the inner rows 40, 50, 60, 70, 80, 90 when the head portions 210, 330 are inserted through the respective projection-receiving channel 350. When inserted, the head portions 210 and 330 are positioned outside of the respective sliding cap 100, with the projections 170, 180, 290, 300, 310, 320 residing inside the respective projection-receiving channel 350. In other embodiments, one or more of the sliding caps 100 may include fewer than both of the guiding surfaces 410.

In the illustrated embodiment, the sliding cap 100 includes two pairs of recesses 420, 430 that are formed in inner surfaces 360, 370 and configured to receive the upper and lower protrusions 220, 230 of the end rows 20, 30. That is, the upper and lower protrusions 220, 230 of the end row 20 are receivable into the pair of recesses 420 on one sliding cap 100, and the upper and lower protrusions 220, 230 of the end row 30 are receivable into the pair of recesses 430 on another sliding cap 100.

In the illustrated embodiment, the sliding cap 100 is substantially symmetrical about a centerline axis 440 extending substantially perpendicular to the longitudinal axis 400. As will be explained further below, the symmetrical shape of the sliding caps 100 can facilitate a modular construction of the tube rack 10.

Referring again to FIG. 2, in assembly, the end rows 20, 30, and the inner rows 40, 50, 60, 70, 80, 90 are aligned, with the first inner rows 40, 90 adjacent an inside of the end rows 20, 30, respectively, the second inner rows 50, 80 adjacent an inside of the first inner rows 40, 90, respectively, and the third inner rows 60, 70 adjacent an inside of the second inner rows 50, 80, respectively. In this configuration, the projections 170, 180, 290, 300, 310, 320 will be vertically staggered or stepped, with a pair of adjacent projections extending at substantially the same height above a supporting structure, such as a table or lab bench. Next, sliding caps 100 are inserted onto each pair of adjacent projections that are at substantially the same height. When thus assembled, 14 sliding caps 100 can couple the end rows 20, 30 and the inner rows 40, 50, 60, 70, 80, 90 of the tube rack 10 together. Referring also to FIG. 1, on a side face 14 of the tube rack 10, two sliding caps 100 extend along the bases 200 of the wells 110, three additional sliding caps 100 extend above the bases 200 in a staggered or stepped configuration, and two sliding caps 100 extend along the top walls 260. As described above, one row in each pair appears to be the same as the other row in that pair, except rotated 180° about a centerline axis substantially perpendicular to the respective longitudinal axis 120. Thus, the rows within each pair are interchangeable. As such, the construction of the tube rack 10 can be modular. Moreover, the tube rack 10 can be lengthened or shortened by adjusting the number of rows used in assembly.

Referring to FIG. 10, a user such as a laboratory professional can expand the tube rack 10 from a storage configuration to an operating configuration, for example by grasping the tabs 144 of the end rows 20, 30 and pulling the end rows 20, 30 laterally away from each other. While the end rows 20, 30 are fixedly coupled to the respective sliding caps 100 via the upper and lower protrusions 220, 230, the inner rows 40, 50, 60, 70, 80, 90 are slidably coupled to the projection-receiving channels 350, allowing the tube rack 10 to expand to a larger footprint.

Referring to FIG. 11, the tube rack 10 is fully expanded when each of the projections 170, 180, 290, 300, 310, 320 are abutting against a respective inner side surface 380, 390 of the sliding cap 100. In the fully expanded configuration, the rows 20, 30, 40, 50, 60, 70, 80, and 90 are separated from one another, making the loading and retrieving of individual test tubes efficient and user-friendly. The tube rack 10 can be subsequently contracted or closed, for example by pushing the tabs 144 of the end rows 20, 30 laterally toward each other. As illustrated in FIG. 1, in the closed configuration, the tube rack 10 allows the user to store test tubes T tidily and in a compact footprint. The assembly of the tube rack 10 and test tubes T can be subjected to further processing such as refrigeration or autoclaving.

Although the illustrated embodiment uses sliding caps 100 to slidably couple the rows of wells, other embodiments may use other suitable sliding mechanisms, such as linkages or hinges. Moreover, in the illustrated embodiment, wells slide in rows relative to each other; however, in other embodiments, one or more independent or uncoupled wells may slide within a row, thereby creating a rack that can expand in two directions: (1) a lateral direction extending between the end rows 20, 30, and (2) a longitudinal direction substantially perpendicular to the lateral direction.

Referring again to FIGS. 1 and 2, the tube rack 10 optionally includes a lid 450. The lid 450 is configured to cover the rows 20, 30, 40, 50, 60, 70, 80, and 90 in the closed configuration. For example, the lid 450 includes abutment stops 460 for aligning with the side walls 140 of the end rows 20, 30. Although the illustrated embodiment includes two abutment stops 460, it is to be appreciated that in other embodiments a single abutment stop may be arranged on one side of the lid 460. In further embodiments, the lid 450 latches or snaps to one or more of the end rows 20, 30 for retaining the respective end row 20, 30. In the illustrated embodiment, the lid 450 is generally square when viewed from above. In other embodiments, however, the number of wells 110 may vary, and the lid 450 may assume any geometric shape to suitably cover the wells when the tube rack 10 is in the closed configuration. The lid 450 can be formed from a substantially transparent or translucent material so that the inside is visible to a user.

Although the invention has been described in detail with reference to certain preferred embodiments, variations and modifications exist within the scope and spirit of one or more independent aspects of the invention as described.

What is claimed is:

1. A tube rack comprising:
two or more rows of wells, the rows extending substantially parallel to one another; and
at least one coupling member for coupling a pair of rows, wherein each coupling member is configured to adjust a distance between the pair of rows as the rows of wells are separated or pushed together, thereby enabling the tube rack to expand and contract.

2. The tube rack of claim 1, wherein each row has an end portion and a projection from the end portion, wherein the coupling member includes a sliding cap having a projection-receiving channel therein, wherein a projection from each of two of the rows of wells is receivable into a respective projection-receiving channel of the sliding cap, wherein the projections slide within the channel when received therein as the rows of wells are separated or pushed together, and wherein the projection-receiving channel of the sliding cap is configured to accommodate sliding of the projections when the projections are positioned within the projection-receiving channel.

3. The tube rack of claim 2, wherein the rows each define a bottom, and wherein the two or more rows each include a projection extending at substantially the same height relative to the bottom.

4. The tube rack of claim 3, wherein the projections of adjacent rows extend at substantially the same height relative to the bottom.

5. The tube rack of claim 3, wherein at least three rows extend substantially parallel to one another, and wherein the projections of adjacent rows are staggered in height relative to the bottom.

6. The tube rack of claim 3, wherein each sliding cap extends laterally at a respective height relative to the bottom.

7. The tube rack of claim 3, wherein at least two sliding caps extend laterally, and wherein adjacent sliding caps are staggered in height relative to the bottom.

8. The tube rack of claim 2, wherein each row defines an end portion width, and wherein at least one of the sliding caps has a length of approximately three times the end portion width or more.

9. The tube rack of claim 2, wherein at least one of the projections includes a head portion and a body portion, the head portion being larger in cross section than the body portion.

10. The tube rack of claim 2, wherein each row includes a first end portion with a first projection and a second end portion opposite the first end portion with a second projection, wherein each row defines a longitudinal axis extending from the first end portion to the second end portion, and wherein the first projection is substantially symmetrical in shape to the second projection when viewed along a centerline axis extending substantially perpendicular to the longitudinal axis.

11. The tube rack of claim 2, wherein at least one sliding cap defines a longitudinal axis and the sliding cap is substantially symmetrical in shape about a centerline axis extending substantially perpendicular to the longitudinal axis.

12. The tube rack of claim 2, wherein at least one sliding cap defines an inner side surface, and wherein a respective projection of one row abuts the inner side surface when the tube rack is expanded.

13. The tube rack of claim 2, wherein at least one row defines a top wall and a bottom extending opposite the top wall, and wherein the top wall and bottom each define openings for receiving a tube therein.

14. A tube rack comprising:
three or more rows of wells, the rows extending substantially parallel to one another, each row having two or more wells and defining a longitudinal axis; and
at least two coupling members for coupling a respective pair of rows, wherein each coupling member is configured to adjust a distance between the respective pair of rows as the rows of wells are separated or pushed together in a direction substantially perpendicular to the longitudinal axes, thereby enabling the tube rack to expand and contract.

15. The tube rack of claim 14, wherein each row has an end portion, a projection from the end portion, and a bottom, wherein the coupling members include sliding caps each including a projection-receiving channel therein, wherein a projection from each of two of the rows of wells is receivable into a respective projection-receiving channel of the sliding cap, wherein the projections of adjacent rows are staggered in height relative to the bottom, wherein the projections slide within the channel when received therein as the rows of wells are separated or pushed together, and wherein the projection-receiving channel of the sliding cap is configured to accommodate sliding of the projections when the projections are positioned within the projection-receiving channel.

16. The tube rack of claim 15, wherein a first row has a first projection extending at a first height relative to the bottom, wherein a second row has a second projection extending at the first height and a third projection extending at a second height relative to the bottom, and wherein a third row has a fourth projection extending at the second height.

17. The tube rack of claim 15, wherein at least three sliding caps extend laterally, and wherein adjacent sliding caps are staggered in height relative to the bottom.

18. The tube rack of claim 15, wherein each row defines an end portion width, and wherein at least one of the sliding cap has a length of approximately three times the end portion width or more.

19. The tube rack of claim 15, wherein at least one of the projections includes a head portion and a body portion, the head portion being larger in cross section than the body portion.

20. The tube rack of claim 15, wherein each row has a first end portion, a first projection from the first end portion, a second end portion opposite the first end portion, and a second projection from the second end portion, and wherein the first projection is substantially symmetrical in shape to the second projection when viewed along a centerline axis extending substantially perpendicular to the longitudinal axis.

21. The tube rack of claim 15, wherein at least one sliding cap defines an inner side surface, and wherein a respective projection of one row is abutting against the inner side surface when the tube rack is expanded.

22. The tube rack of claim 15, wherein at least one row defines a top wall and a bottom extending opposite the top wall, and wherein the top wall and bottom each define openings for receiving a tube therein.
